(19) United States
(12) Patent Application Publication
(10) Pub. No.: US 2009/0171907 A1
(43) Pub. Date: Jul. 2, 2009

(54) Method and system for searching text-containing documents

(76) Inventor: Nash R. Radovanovic, Thornhill (CA)

Correspondence Address: DENNISON ASSOCIATES, 133 RICHMOND STREET WEST, SUITE 301, TORONTO, ON, M5H 2L7, CA

(21) Appl. No.: 12/003,395

(22) Filed: Dec. 26, 2007

(51) Int. Cl. G06F 17/30

(52) U.S. Cl. 707/3; 707/E17.001

(57) ABSTRACT

The invention relates to a method, system, software and computer processor for searching an information store, in which documents containing searchable text are stored, for specific information on a particular topic. A search query is input into a search interface. The search query is processed to generate a search string incorporating search terms relating to the search query. The search string is transferred to at least one search engine to generate a preliminary set of potentially relevant results, each result with a link to an underlying document in the information store. The links are automatically followed to the underlying documents and the search terms are located therein. A text extract from the full searchable text of each underlying document is automatically selected based on the location of the search terms therein and pre-determined criteria applied thereto. A results list is generated by adding the text extract and other information relating to the underlying document as an entry in the results list. For each text extract, any words therein which are unique as compared to the text extracts for all other entries in the results list are identified. At least one entry with one or more unique words associated therewith is selected from the results list. A modified search query is automatically generated based on the one or more unique words. The modified search query is transferred to the at least one search engine to generate a modified list of results and the process repeated.

### FIELD OF THE INVENTION

The invention relates to a method and system of searching an information store, in which documents containing searchable text are stored, such as the Internet or a database, for useful information relating to a particular topic.

### BACKGROUND OF THE INVENTION

Vast and ever increasing quantities of information and documents are available via electronic means from various information stores, such as various databases, the world-wide computer network known as the Internet or smaller networks known as intranets. Locating information and/or documents relevant to a user is a difficult process which can be time-consuming, inexact and frustrating.

Typically, a user seeking information on a particular topic will input a search query consisting of a question or search terms (i.e. keyword(s) or phrase(s)) relevant to that topic into the search interface of search engine program, such as those provided under the trademarks GOOGLE, YAHOO, ALTA VISTA and LIVESEARCH. Some search engines, known as metasearch engines (such as those provided under the trademarks DOGPILE and MOMMA), specialize in conducting and collating the results of searches done on other search engines.

Upon input of a search query, a search engine will search the information store of interest looking for documents which refer in some manner to the terms in the query. In the context of an Internet search, the search engine is seeking potentially relevant webpages, which for the purposes of the present invention are merely a particular type of document, or documents linked to the Internet by a webserver.

The search engine will then return to the user the search results listing any documents which the search engine has, according to its proprietary internal operation, identified as potentially relevant. In some cases, results are listed according to the search engine's proprietary assessment as to how the results should be prioritized. Depending on the search query used, the lists of results can be dauntingly large, in some cases representing millions of hits.

More specifically, the search results usually takes the form of a report in which each individual entry comprises a title for the document, a brief text extract from the underlying document and a link to the underlying document. Notwithstanding that the conventional search engine returns a list of allegedly relevant documents, the challenge for a user can be to review the many hits to determine which (if any) documents in fact are actually relevant to the user's inquiry. With conventional search engine results, it would be common for a user merely to review, without any confidence as to real relevance, a limited number of the initial results presented by the search engine for whatever value may be gleaned just therefrom.

Typically, the brief extracts from the underlying documents provided in a conventional search report usually consist of only a few words or a couple of lines in the vicinity(ies) of one or more terms used in the search query. These extracts thus offer a limited amount of information to a user regarding the underlying documents located in the search. To make a better assessment of relevance, the user is often forced to manually follow one or more links in the search report to the underlying documents, locate the portions of the underlying documents which refer to the term(s) in the search query and make specific assessments as to whether the documents are in fact of interest. The process can be slow and painstaking as the user works his or her way through a potentially long list of entries in the search report.

Conventional search results typically include numerous entries which, depending on the nature of the searcher's inquiry, are not likely to be relevant. There are many potential reasons for this, particularly in respect of Internet searches. One major possibility is that the user may not have specified the initial search query narrowly enough—e.g. if a user is searching for information on the history of “television” and accordingly enters the search query “television”, then documents relating to the sale of “televisions” or of “television” shows on DVD or to the science of “television” or to “television” stars are not likely to be relevant.

However, another major possibility is that “search engine optimization” or “SEO” (a term collectively describing various techniques and processes used by Internet website owners to try to manipulate and control the presentation of search engine results in an effort to ensure that their information is listed at or near the top of a search report) may have skewed the search results in some manner. For example, various SEO techniques include:
a. placement of repetitive or keywords or phrases on a webpage, either as text (e.g. visible or hidden, e.g. white text on white background or a miniscule compressed font) or as meta tags. For example, if such words or phrases relate to topics that searchers might be looking for, their inclusion on a webpage (even if totally unrelated to the true content of the webpage) may allow a search engine to find that webpage and thus attract a searcher to that webpage. Once a searcher has landed on a webpage, the website owner will present its own information, usually advertising and usually irrelevant to the search query, directly or indirectly (e.g. by re-directing the searcher to another webpage);
b. creation of numerous domains and interlinking them, so as to influence (for example) a search engine's “page popularity” component of a ranking system and thus achieve a higher ranking and position in a search report;
c. payment for on-line traffic. For example, a search engine provider may have a business model that allows it to derive revenues from website owners who pay to use certain keywords to ensure that the search engine provider lists their webpage at or near the top of a search report in response to a search query which includes such keywords. The keywords may not have anything to do with the webpage content.

In many cases, search engine providers will take steps to try to counteract at least some such manipulations of their search results, sometimes with success and sometimes not. In some cases, particularly if revenue may be generated, search engine providers will agree and participate in allowing some such manipulations. Nevertheless, whatever the reason for its inclusion in a search report, all such extraneous information must be sorted through by the user in an effort to identify information of true interest.

Frequently, in conducting a search, a user will find that the initial search results are not adequate for his or her purposes. The user will therefore wish, in subsequent iterations of the search, to refine the search by presenting a more precise search query which he or she believes will be more likely to generate more relevant search results. At its most basic, a user may simply manually add additional search terms to the original search query. In some cases, search engines will present suggestions to the user for possible additional or alternative terms related to the term(s) in the original query, such as might be generated by a thesaurus. The difficulties with these basic approaches are that use of the additional/alternative terms may or may not generate additional or better information of specific interest to the user and, moreover, that many users do not have sufficient searching skills to craft a truly improved search query.

To assist users in refining search queries, the concept of relevance feedback has been developed for use in search engine systems. In one type of relevance feedback system, each underlying document in the information store is associated with various keywords, either fixed or generated dynamically in response to an initial search query. When the initial search results are presented to the user, those keywords are additionally also presented and the user may choose one or more such keywords as additional or alternative terms to be used in a modified search query.

In another type of relevance feedback system, when initial search results are presented to a user, he or she may then identify which entries are relevant or not, e.g. by marking suitable check boxes. In effect, the user provides “feedback” to the search engine as to the “relevance” of the search engine's initial results. That feedback is then used by the search engine either: (a) to present to the user a dynamically generated list (derived from the initial search report or from the underlying documents) of possible additional search terms which, upon selection by the user, are in turn incorporated into a modified search query; or, (b) to automatically generate a modified search query.

As to dynamically generated lists of user selectable additional search terms, U.S. Pat. No. 6,947,930 to Anick et al discloses various methods to analyze initial search results to present a set of possible search refinement terms to a user. For example, methods identified as “hyperindexing” and “clustering” analyze the text extracts in the search report to identify various noun phrases containing the initial search query, which noun phrases in turn may be used to populate the list of possible selections presented to the user. Another method identified as “paraphrase” (see also Anick, P. et al, “Interactive Document Retrieval using Faceted Terminological Feedback”, Proceedings of the 32^{nd} Hawaii Conference on System Sciences, 1999) analyses the full text of the underlying documents and, based on the concept of lexical dispersion (i.e. identifying all phrases of a defined structure used in the underlying documents which combine the initial search query with another word or words), to identify some such phrases to populate the list of possible selections presented to the user.

Once again, the difficulties with the above approaches are that the possible additional search terms suggested by the search engine may or may not generate additional or better information of specific interest to the user. In addition, methods which focus on the full text of underlying documents risk including irrelevant material and are computation intensive. Methods which focus on the brief text extracts returned in a conventional search report risk excluding relevant material. Methods based on identification of noun or other natural language phrases may exclude relevant material in cases where the search query was not necessarily a natural language phrase (in which case the terms used in the initial search query might not necessarily be located together in an integrated natural language phrase in the underlying document or any extracts therefrom).

In another method disclosed in U.S. Pat. No. 6,947,930, attributed to Velez et al, all documents in the corpus of the relevant database have their individual words pre-mapped to a set of terms that might relate thereto and might be used in a modified search query. When a search query is received containing a word in the corpus, the set of terms pre-mapped thereto are returned to the user as the list of possible selections for a modified search query. Such a system requires a substantial amount of pre-search computation and, for large dynamic stores of unregulated and non-standard data such as the Internet, may not be practical.

As to automatically generated modified search queries, Koenemann, J. et al (A Case for Interaction: A Study of Interactive Information Retrieval Behavior and Effectiveness, Proceedings of the Human Factors in Computing Conference, Chicago, 1996) has postulated three models for relevance feedback. In a basic “opaque” model, a user simply specifies the entries in the search results that he or she considers relevant and enters no other information. In Koenemann's case, the search engine generates a refined search query based on a proprietary algorithm based on the full text of the underlying documents.

In a “transparent” model, as for the basic “opaque” model, a user again merely specifies the entries in the search results that he or she considers relevant and enters no other information. In this model, however, the automatically generated modified search query is displayed to the user after the modified search is complete. This may provide useful additional information to the user and may suggest additional search strategies to him or her.

In a “penetrable” model, the automatically generated modified search query is displayed to the user before execution. The user is provided with the opportunity, if he or she wishes, to accept or to revise the modified search query.

Although the transparent and penetrable models of relevance feedback potentially provide greater control over the searching process (and are thus preferable to some users), the fact remains that a large percentage of users and potential users do not have the skills or experience to make effective use of such models. In addition, the focus on the full text of the underlying documents risks including irrelevant material.

In view of the above-described prior art, there remains a need for a simple yet effective method of searching a document store of documents containing searchable text for useful information relating to topics of interest.

### SUMMARY OF THE INVENTION

The present invention provides a method of searching an information store, in which documents containing searchable text are stored, for specific information. A search query is input into a search interface. The search query is processed to generate a search string incorporating search terms relating to the search query. The search string is transferred to at least one search engine to generate a preliminary set of potentially relevant results, each result with a link to an underlying document in the information store. The links are automatically followed to the underlying documents and the search terms are located therein. A text extract from the full searchable text of each underlying document is automatically selected based on the location of the search terms therein and pre-determined criteria applied thereto. A results list is generated by adding the text extract and other information relating to the underlying document as an entry in the results list. For each text extract, any words therein which are unique as compared to the text extracts for all other entries in the results list are identified. At least one entry with one or more unique words associated therewith is selected from the results list. A modified search query is automatically generated based on the one or more unique words. The modified search query is transferred to the at least one search engine to generate a modified list of results and the process repeated.

In another aspect, the invention comprises a computer data processing system for searching an information store, in which documents containing searchable text are stored, for specific information in response to a user search query, is provided. The system includes a first user interface for entering a search query, a display device for displaying reports, a second user interface for inputting data in response to a displayed report, at least one search computer processing means connected to the information store for searching the information store in response to a search string inputted thereto and a central computer connected to the at least one search computer processing means, the first and second user interfaces and the display device. The central computer receives and processes the search query to generate a search string incorporating search terms relating to the search query. It then transfers the search string to the at least one search computer processing means and subsequently receives from the at least one search computer processing means a preliminary set of potentially relevant results, each result with a link to an underlying document in the information store. The central computer automatically follows the links to the underlying documents and locates the search terms therein. It then automatically selects a text extract from the full searchable text of each underlying document based on the location of the search terms therein and pre-determined criteria applied thereto. Next, the central computer generates a results list by adding the text extract and other information relating to the underlying document as an entry in the results list. A report based thereon is prepared for display on the display device. The central computer identifies, for each text extract, any words therein which are unique as compared to the text extracts for all other entries in the results list. The central computer receives from the second user interface user relevance data relating to at least one entry in the results list with one or more unique words associated therewith and automatically generates a modified search string based on said one or more unique words. The search is iterated by transferring the modified search string to the at least one search computer processing means to generate a modified results list.

In a further aspect, the invention is computer software for searching an information store, in which documents containing searchable text are stored, for specific information in response to a user search query, comprising a computer usable medium having computer-readable program code embodied therein. The computer-readable program code comprises a first program code for receiving and processing the search query to generate a search string incorporating search terms relating to the search query, a second program code for transferring the search string to at least one search computer processing means connected to the information store for searching the information store in response to the search string, a third program code for receiving from the at least one search computer processing means a preliminary set of potentially relevant results, each result with a link to an underlying document in the information store, a fourth program code for automatically following the links to the underlying documents and locating the search terms therein and for automatically selecting a text extract from the full searchable text of each underlying document based on the location of the search terms therein and pre-determined criteria applied thereto, a fifth program code for generating a results list by adding the text extract and other information relating to the underlying document as an entry in the results list and for outputting a report based thereon for display on a display device, a sixth program code for identifying, for each text extract, any words therein which are unique as compared to the text extracts for all other entries in the results list, and a seventh program code for receiving user relevance data relating to at least one entry in the results list with one or more unique words associated therewith and for automatically generating a modified search string based on said one or more unique words and for transferring the modified search string to said at least one search computer processing means to generate a modified results list.

In yet a further aspect, the invention comprises a computer processor for searching an information store, in which documents containing searchable text are stored, for specific information in response to a user search query. The processor is adaptable to be connected to the information store and to at least one search computer processing means connected to the information store for searching the information store in response to a search string inputted thereto, a first user interface for entering a search query, a display device for displaying reports, and a second user interface for inputting data in response to a displayed report. The processor comprises means for receiving from the first user interface and processing the search query to generate a search string incorporating search terms relating to the search query, means for transferring the search string to the at least one search computer processing means, means for receiving from the at least one search computer processing means a preliminary set of potentially relevant results, each result with a link to an underlying document in the information store, means for automatically following the links to the underlying documents and locating the search terms therein, means for automatically selecting a text extract from the full searchable text of each underlying document based on the location of the search terms therein and pre-determined criteria applied thereto, means for generating a results list by adding the text extract and other information relating to the underlying document as an entry in the results list and outputting a report based thereon for display on the display device, means for identifying, for each text extract, any words therein which are unique as compared to the text extracts for all other entries in the results list, means for receiving from the second user interface user relevance data relating to at least one entry in the results list with one or more unique words associated therewith, means for automatically generating a modified search string based on said one or more unique words, and, means for transferring the modified search string to said at least one search computer processing means to generate a modified results list.

### BRIEF DESCRIPTION OF THE DRAWINGS

Preferred embodiments of the present invention are illustrated in the attached drawings, in which:

FIG. 1 (Prior Art) is a block diagram of a typical prior art system, featuring a prior art search engine, for searching a document store, such as a database or the Internet;

FIG. 2 (Prior Art) is a block diagram of a typical prior art system, featuring a prior art search engine, for searching the Internet;

FIG. 3 (Prior Art) is a print-out of a typical search report generated by a typical prior art search engine according to its proprietary processes;

FIG. 4 (Prior Art) is a block diagram of another typical prior art system, featuring a prior art meta-search engine, for searching the Internet;

FIG. 5 is a block diagram of a system according to the invention for searching a document store, such as a database or the Internet;

FIG. 6 is a block diagram of a system according to the invention for searching the Internet;

FIG. 7 is a flow chart illustrating the method of the invention in its broadest aspects.

FIG. 8 is a drawing of the user input interface to input a search query to be processed in accordance with the invention.

FIG. 9 is a flow chart illustrating the preliminary processing of a user-input data.

FIG. 10 is a flow chart illustrating the preliminary processing of a user-inputted search query.

FIG. 11 is a flow chart illustrating the performance of an initial search based on the processed search query.

FIG. 12 is a flow chart illustrating the processing of the processed search query to generate a search string.

FIG. 13 is a flow chart illustrating the process of generating a search string.

FIG. 14 is a flow chart illustrating the performance of a search based on the processed search query and the processing of the results derived therefrom.

FIG. 15 is a flow chart illustrating the processing of a set of links derived from a search.

FIG. 16 is a flow chart illustrating the automatic retrieval, based on the processed set of links, of the underlying webpages and the selection of a portion of the full searchable text thereof for inclusion in a preliminary search report.

FIG. 17 is a flow chart illustrating the preliminary processing of text in an underlying document.

FIG. 18 is a flow chart illustrating the automatic selection, based on predetermined rules, of a portion of the full searchable text of a document for inclusion in a preliminary search report.

FIG. 19 is a flow chart illustrating the automatic location of search terms in a document and the identification of processing start and end points in the text.

FIG. 20 is a flow chart illustrating the automatic location of text selection start and end points, based on predetermined rules.

FIG. 21 is a flow chart illustrating the processing of a text selection to map any unique words therein into a word array associated with the text selection.

FIG. 22 is a flow chart illustrating the processing of text selections and data related thereto into a final data set for inclusion in a final report.

FIG. 23 is a flow chart illustrating the processing of search result data and other relevant information into a final report.

FIG. 24 is a print-out a typical search report generated according to the method of the invention which additionally illustrates the user interface for inputting relevance data back to the system.

FIG. 25 is a flow chart illustrating the process of iterating a search based on user inputted relevance data in response to a previous search report.

### DETAILED DISCLOSURE

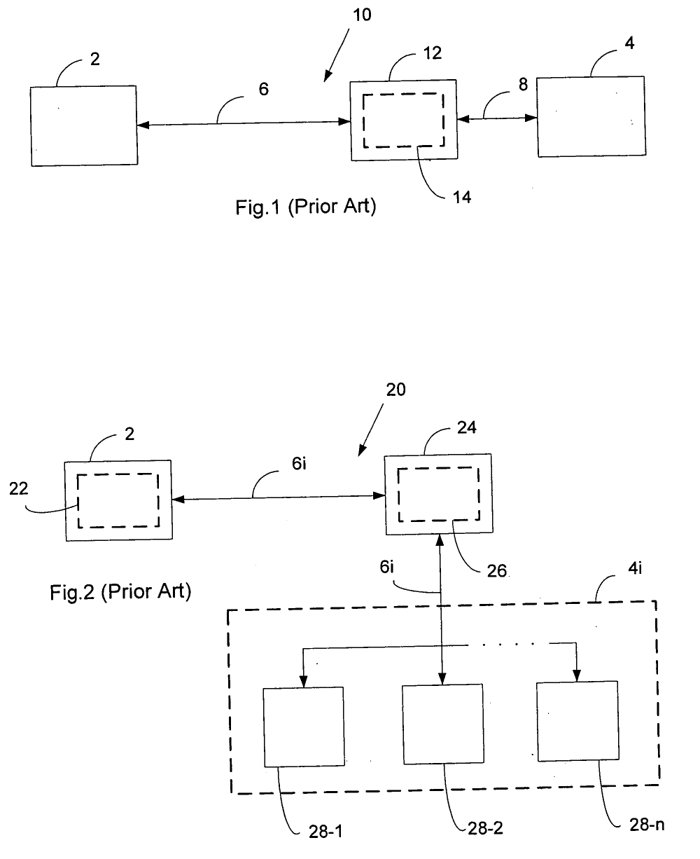

Referring to FIG. 1, a typical prior art system 10 for allowing a user at computer or terminal 2 to search an electronic document store 4 for electronic documents stored therein is shown. Document store 4 represents a collection of documents containing or associated with searchable text. Such collections may take various forms, such as one or more searchable databases, the Internet or an intranet. The documents in document store 4 may include any type of document containing, associated with or linked to searchable text, such as a webpage or any other text-based or text-containing document. The documents may even include image-based documents provided that they have been associated with or linked to searchable descriptive text.

A user computer or terminal 2 is linked by communication channel 6 to a search computer or server 12 on which a prior art search engine or search software 14 is installed. Server 12 is linked by communication channel 8 to document store 4. In response to a search query input by a user (not shown) at computer 2, the search engine or software at server 12 will search document store 4 for documents which relate to the search query and return a suitable report to computer 2 for review by the user. Referring to FIG. 2, the document store is specifically the Internet 4i and a more specific but still typical prior art system 20 for allowing a user to search the Internet 4i for electronic documents accessible on the Internet 4i (including web content such as webpages and searchable documents posted to the Internet 4i via servers) is shown. In this case, the communication channel to and from the user computer 2 is the Internet 6i, achieved by conventional telecommunication means such as through suitable hardware and an internet service provider (none shown).

In this specification, reference to the term “Internet 6i” shall be understood as referring to the Internet as means of communication and reference to the term “Internet 4i” shall be understood as referring to the Internet as a document store or collection of documents, as described above. In the drawings, although for convenience in describing functional aspects of the invention separate connections may be shown to “Internet 4i”, it will be understood that there will typically be only one connection in fact and that it is the functional significance of such connection which will change as described.

To conduct a search for information or documents of interest, using a suitable web browser 22 installed on computer 2, computer 2 communicates via Internet 6i with a server 24 which hosts a website providing a conventional search engine 26, such as for example GOOGLE. In response to a search query input by the user, search engine 26 searches the Internet 4i for web content, such as webpages and other documents, including those posted by third parties at various other websites, which search engine 26 determines (according to its own methods and algorithms) are relevant. In FIG. 2, search engine 26 is shown linked to various documents 28-1 to 28-n, which in response to a search query it has identified as relevant. Typically, the search results are ranked by the search engine 26 (again according to the search engine's own methods and algorithms) and returned in a search report to computer 2 for display.

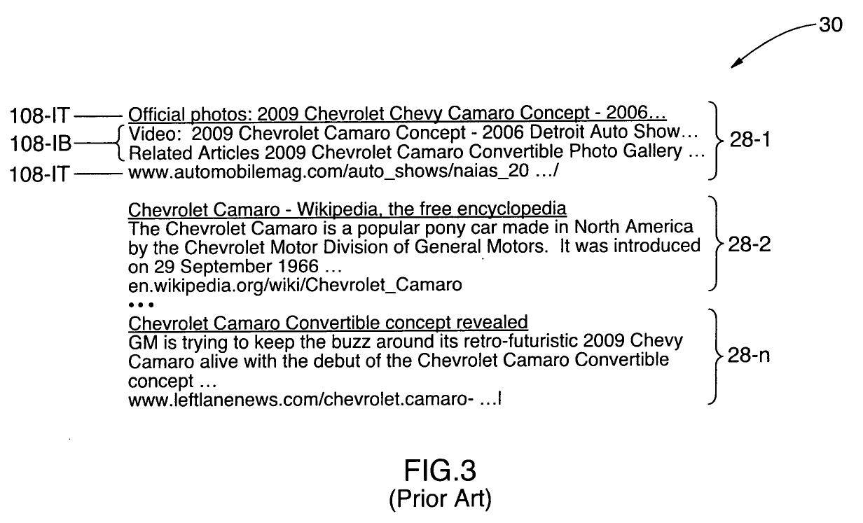

Referring to FIG. 3, there is shown a print-out of the first page of a typical search report 30 generated by a prior art search engine 26 for display at computer 2. In general, the search report lists as its entries the various documents 28-1 to 28-n identified as relevant. Typically, each entry consists of a document title (e.g. as shown at 28-1T), a brief extract of text from the document (e.g. as shown at 28-1B) and a link to the document itself (e.g. as shown at 28-1L). The link is usually provided directly by the “universal resource locator” or “URL” designation of the underlying document and also indirectly by the title (e.g. at 28-1T). By clicking on an active link (e.g. URL or title), the user's web browser 22 retrieves the underlying document via the Internet 6i and delivers it to computer 2 for display.

It is to be noted that in report 30 text extracts (e.g. 28-1B) in entries 28-1 to 28-n are usually about 2 lines in length and are not necessarily in natural language (that is, they can be disjointed words, not sentences). A user reviewing report 30 may find it difficult to determine whether any particular entry 28-1 to 28-n is relevant to his/her true inquiry and he/she may be forced to follow each link to review the underlying document for true relevance to him/her.

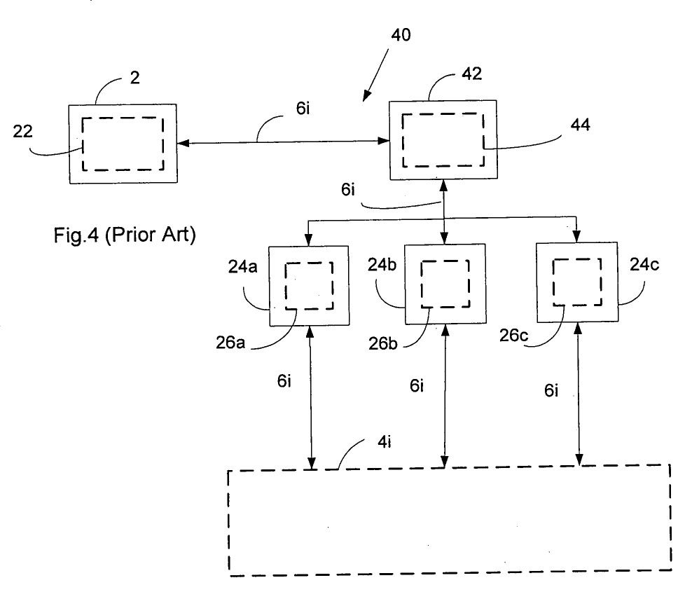

Referring to FIG. 4, another prior art system 40 is shown in which server 42 has installed on it another search engine 44. Search engine 44, known as a “meta-search engine”, instead of directly searching the Internet 4i, indirectly searches the Internet 4i via other search engines. More specifically, a search query from user computer 2 is received by meta-search engine 44 and is in turn communicated via Internet 6i to other search engines, in the illustrated case conventional search engines 26a to 26c installed on servers 24a to 24c. In response to the search query, each search engine 26a to 26c generates its own search results (as generally described above in relation to FIG. 2) in accordance with its own methods and algorithms, which are communicated back to meta-search engine 44. Meta-search engine 44 receives and, in accordance with its methods and algorithms, collates the results from all the search engines 26a to 26c and returns an integrated search report to computer 2.

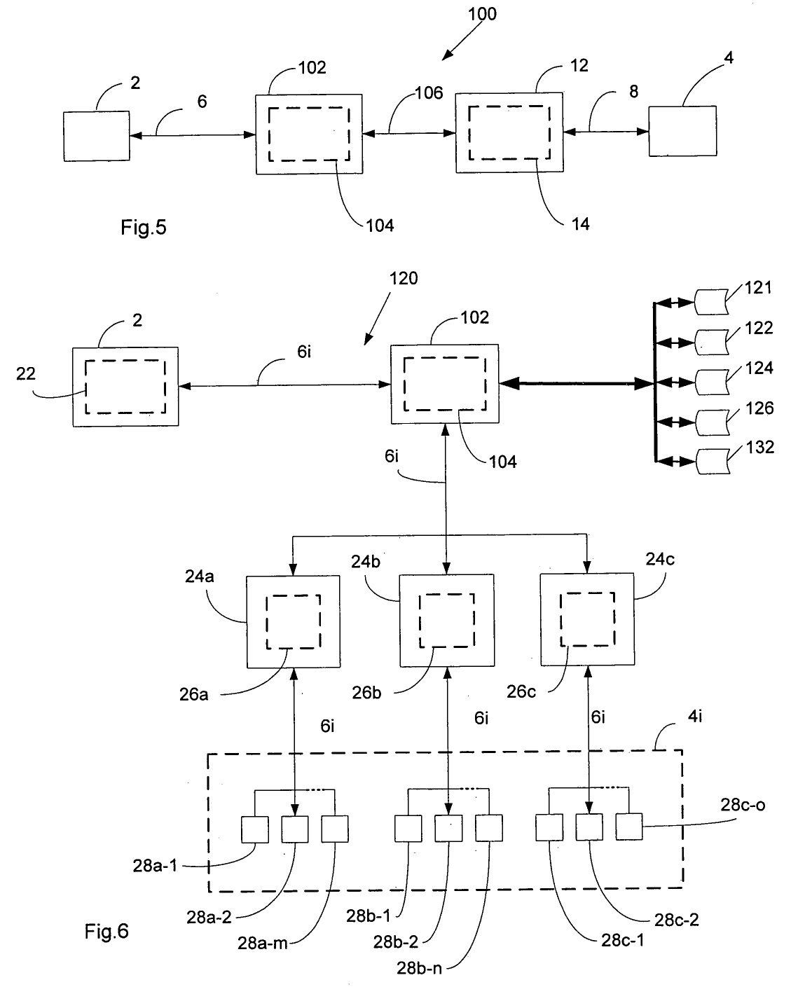

Referring now to FIG. 5, there is generally shown a computer system 100 according to the invention to search document store 4 for electronic documents stored therein. User computer 2 is linked by communication channel 6 to computer or server 102 on which is installed search engine 104 according to the invention. Search engine 104 in turn is linked by communication channel 106 to at least one conventional search engine or search software 14 installed on computer or server 12. Server 12 in turn is connected to document store 4 via communication channel 8. In response to a search query and other user input at computer 2, search engine 104 may, as described in detail below, process the search query and in turn pass a search query to search engine 14. Based on the search query received by it, search engine 14 searches document store 4 for documents which it determines are relevant. Search engine 14 returns its conventional report to search engine 104. As described in detail below, search engine 104 processes the search results and returns a search report to computer 2.

As shown in FIG. 6, system 120 is shown in the specific case where the document store is the Internet 4i. System 120 operates to allow a user to search the Internet 4i for electronic documents (including web content such as webpages and searchable documents). In this case, a user computer 2 with web browser 22 is connected via Internet 6i to server 102 on which search engine 104 according to the invention is installed. Search engine 104 in turn is connected via the Internet 6i to at least one pre-determined conventional search engine 26, for example, as illustrated in FIG. 6, three search engines 26a to 26c installed on servers 24a to 24c respectively. In response to a search query and other user input at computer 2, search engine 104 may process the search query and in turn pass a processed query to search engines 26a to 26c, all as described in detail below. Based on the processed query received, search engines 26a to 26c each independently search the Internet 4i for documents considered relevant. In the example shown in FIG. 6, search engines 26a to 26c are shown linked to various documents 28a-1, 28a-2 . . . 28a-m; 28b-1, 28b-2 . . . 28b-n and 28c-1, 28c-2 . . . 28c-o which they have variously identified as relevant. Each of search engines 26a to 26c returns its conventional search results to search engine 104. It is possible that there will be overlap amongst the search results from the different search engine 26a to 26c. As described in detail below, search engine 104 processes all the returned search results and delivers a single search report to computer 2.

Search engine 104 may be considered as functioning somewhat in a manner of a meta-search engine, in that it does not search the Internet 4i directly but instead does so indirectly namely by communicating with and receiving search results from at least one other search engine 26, for example three search engines 26a to 26c as illustrated. In a preferred embodiment, the necessary details of the search engines 26, such as the URLs therefor, may be stored in search engine storage means 121.

In the preferred embodiment, a common word storage means 122 is linked to server 102. Storage means 122 stores a pre-determined list of common words which will be used in processing to be described below.

In addition, a report information storage means 124 is linked to server 102. Although the substantive content of a report to a user produced according to the invention will as described below be largely based on the returned search results, the formatting of such report must additionally be controlled. In many cases, it may also be necessary or desirable to include additional information in a final search report above and beyond the specific returned search results. Accordingly, all information necessary to prepare a final search report, except for the specific returned search results to be included in the final search report, is stored in storage means 124. This information may for example include templates containing the name, logo and other relevant information associated with the operation of search engine 104. It may also include advertising information, which could be fixed or dynamically linked to a search query, by which the search engine operator generates revenues. In addition, it may also include information for the inclusion of data fields to allow a user to provide input as to relevance of entries in the search report.

In a further embodiment of the invention, server 102 may also be linked to a prior report storage means 126 in which may be stored a database of previous search reports generated by search engine 104 in response to searches previously conducted, including by other users. Such previous search reports may be stored and indexed to the search query, or processed search query, which generated them.

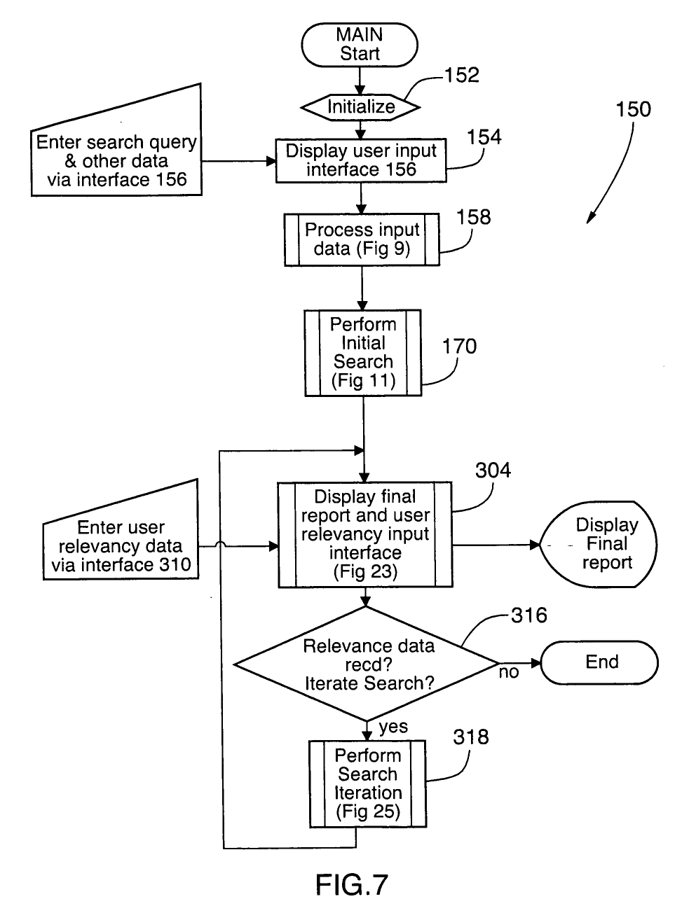

Referring now to FIG. 7, there is generally shown the method 150, according to the invention, by which search engine 104 processes the information received by it and generates and delivers a search report.

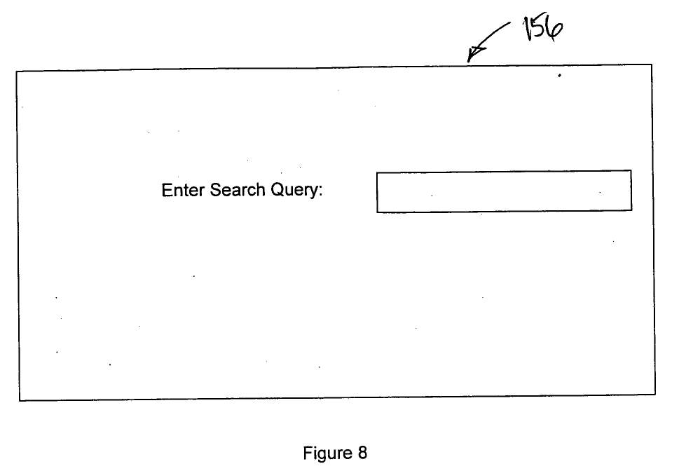

After an initializing step 152, in a display interface step 154, search engine 104 presents an input screen or interface 156 such as generally shown in FIG. 8. Interface 156 allows a user to input into a data field a search query which the user believes will be relevant to a particular topic of interest and lead to the locating of information and documents from the document store to be searched, for example Internet 4i.

Input interface 156 may also, as is commonly done in prior art search engines, provide additional fields (not shown) for data by which a user can control aspects of the anticipated search results, such as maximum number of results, number of results displayed per page, geographic bias and child-safe results only.

In a preliminary processing step 158, the input data may be subject to preliminary processing.

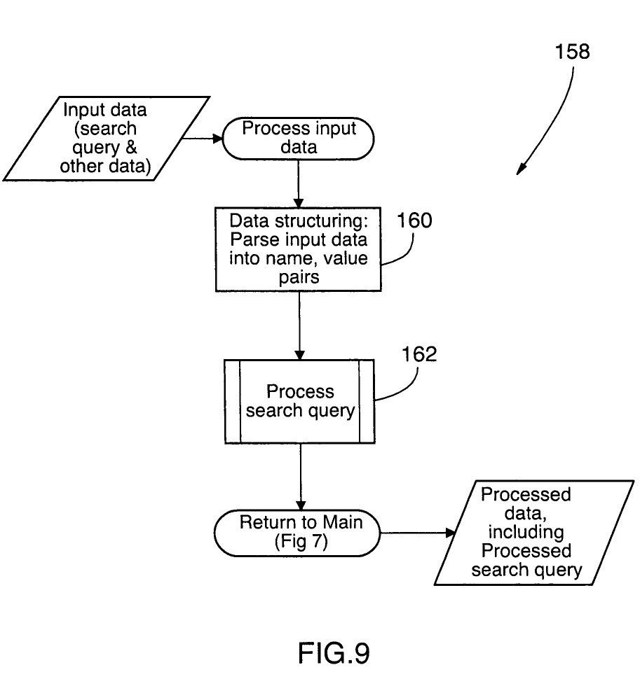

More specially, referring to FIG. 9, in a data structuring step 160, any and all user inputs and any data to be transferred from webpage to webpage are in the normal manner processed into variable name and value pairs.

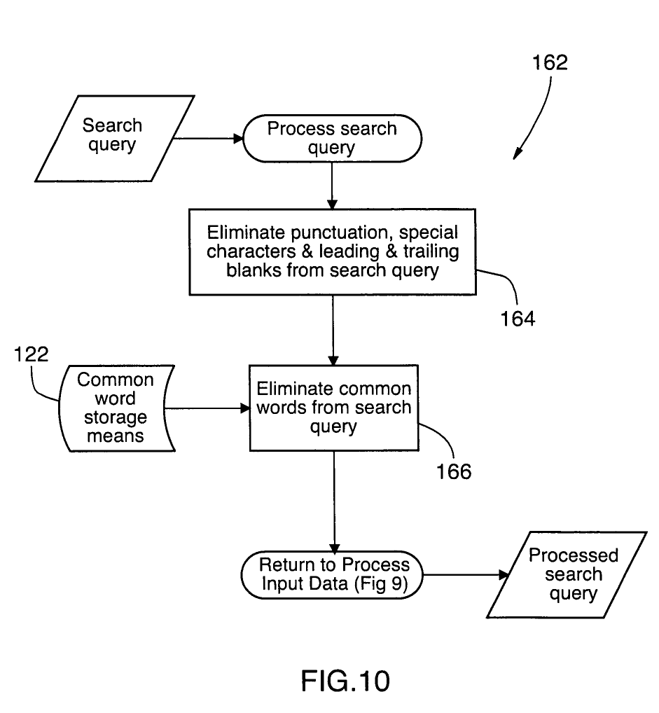

In a preferred embodiment, the search query itself will in a query processing step 162 be processed to result in a final search query that is more likely to be effective in providing useful results to the user. For instance, referring to FIG. 10, in a character elimination step 164, unnecessary characters (such as punctuation, leading and trailing blanks and special characters) may be removed from the search query. By way of example, if the inputted search query were the phrase:

“When was the *# Chevrolet Camaro introduced?”,

after character elimination step 164, the processed search query would be:

“When was the Chevrolet Camaro introduced”.

As a further preferred preliminary query processing step, in common word elimination step 166, various pre-determined common words as stored in common word storage means 122 may be eliminated from the search query. The basis of this step 166 is the recognition that there are many words which, although necessary to a human-understandable natural language sentence or question (and thus may be input as part of a search query), because of their very common nature are unlikely to be of assistance in narrowing a search for information on any specific topic. Put another way, at least some of these common words are highly likely to be used in presenting information on virtually any topic and inclusion of such words in a search query on a specific topic will tend only to include otherwise irrelevant results in a search report. It would therefore be useful to eliminate such common words from a search query.

Some examples of such common words that may usually be safely eliminated from a search query, and thus included in the list stored in memory means 122, would be:
a. articles (e.g. a, an, the)
b. prepositions (e.g. by, in, on, of, from, with)
c. pronouns (e.g. I, me, you, he, she, it, we, they, him, her)
d. relative pronouns (e.g. which, that, whom)
e. possessive words (e.g. my, mine, your, yours, his, hers, our, ours, their, theirs, whose, its)
f. common verbs (e.g. is, was, were, has, have, had)
g. auxiliary verbs: (e.g. could, would, ought, might, will, can, must)
h. question words (e.g. who, what, when, where, why)
i. short words
j. miscellaneous words

Some may advocate not eliminating question words as common words on the basis that these types of words may assist in providing context to the type of information being sought. Using the example above, on the one hand, inclusion of the word “when” in the search query

“When was the Chevrolet Camaro introduced”

may assist in locating information or documents with recognizable dates and more rapid elimination of information or documents which do not make reference to any recognizable date. On the other hand, exclusion of the word “when” from the search query, e.g.

“was the Chevrolet Camaro introduced”,

may make for a simpler search query, more likely to generate useful results, and it may be assumed that information or documents combining the concepts of “Chevrolet”, “Camaro” and “introduced” will be likely to provide relevant date information. For the balance of the description relating to the example, it is assumed that question words (e.g. who, what, when, where, why) will be treated as common words to be eliminated.

Based on the above, in step 166, the search query is processed to eliminate all words stored in memory means 122. Thus, for the example

“When was the Chevrolet Camaro introduced”,

the processed search query becomes

“Chevrolet Camaro introduced”.

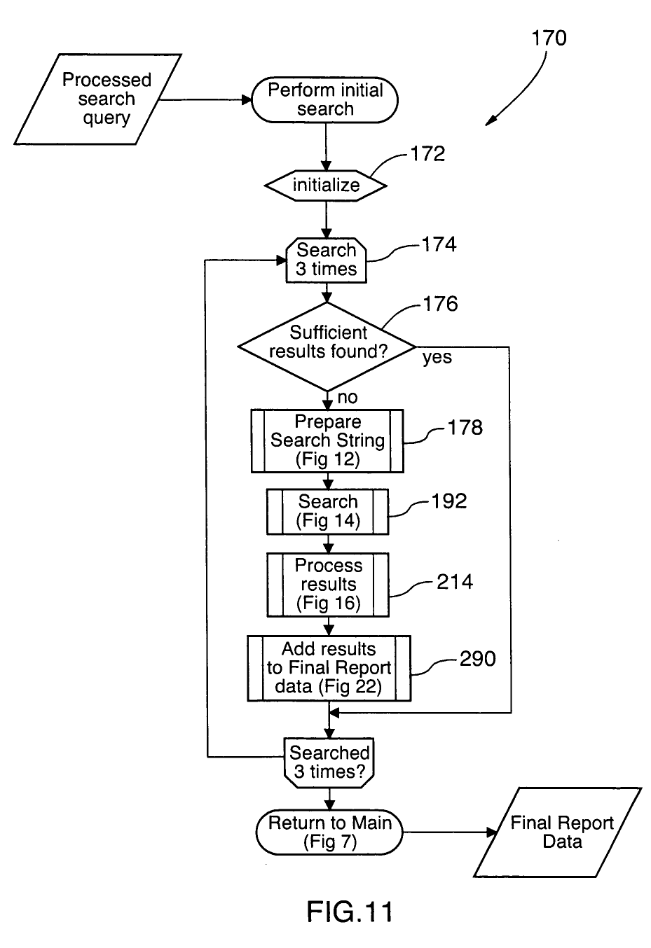

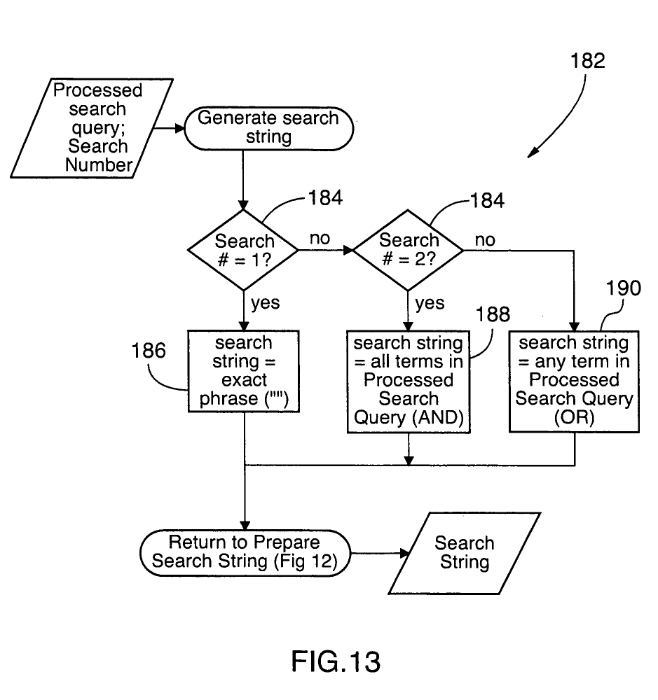

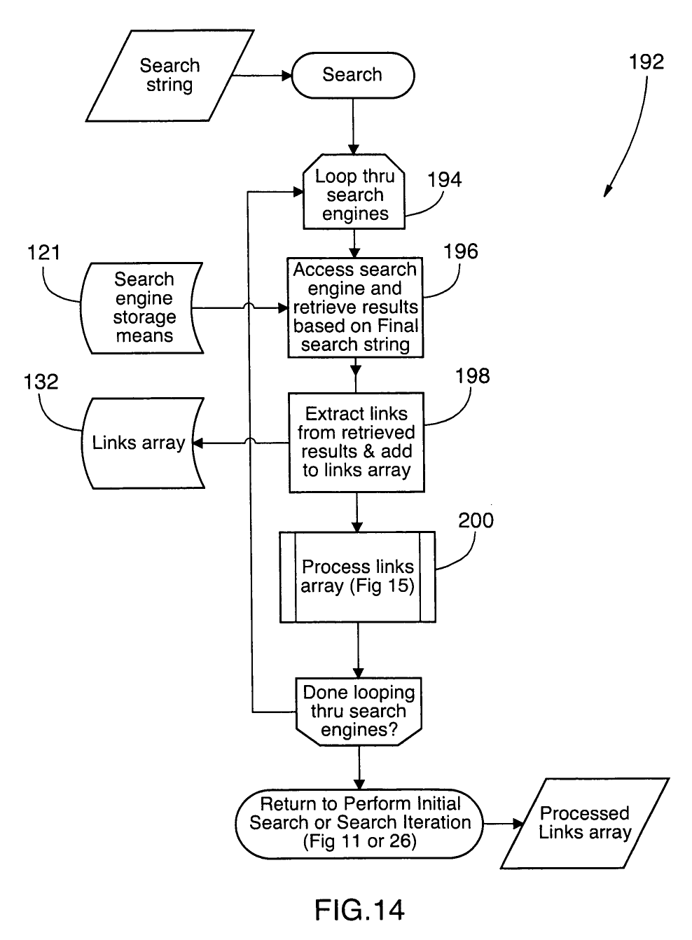

Referring again to FIG. 7, the processed search query from step 166 is then used to perform an initial search in step 170. Preferably the results of the initial search will in fact comprise a combination of the results of separate searches based on a hierarchy of different logical operators which may be more or less likely to return useful results. For example and as shown in FIGS. 11 and 13, it has been found that up to 3 separate searches [representing the use of logical operators to locate: (1) search results for exact matches to the processed search query, (2) search results in which all the terms in the processed search query appear, and (3) search results in which at least one of the terms of the processed search query appear] provide useful results.

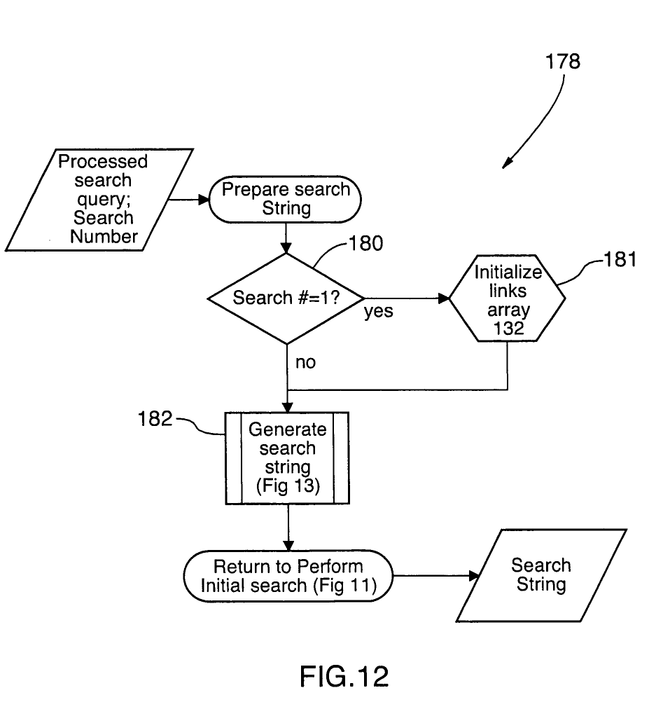

Accordingly, after an initialize step 172, step 170 enters a loop 174 in which the multiple searches are sequentially conducted and the results collated together. At the beginning of loop 174, a test 176 is performed to determine whether a pre-determined sufficient number of results have already been identified. If so, it will not be necessary to perform further searching and the remainder of loop 174 can be by-passed. If not, then the processed search query from step 166 is used in step 178 to prepare suitable specific search strings to be input to search engines 26. Referring to FIG. 12, after a preparatory test 180 to determine if it is the first time through loop 174 and, if so, initializing a links array 132 (the purpose of which is described below) in step 181, a search string is generated in step 182.

Referring to FIG. 13, loop tests 184 are performed to determine which time through loop 174 it is. If it is a first time through loop 174, in step 186, the initial search string is specified to be an exact match to the processed search query. If it is a second time through loop 174, in step 188, the initial search string is specified to be a combination in which all of the terms of the processed search query appear. If it is neither the first nor second time through loop 174 (namely it is the third time through loop 174), in step 190, the initial search string is specified to be a combination in which any of the terms of the processed search query appear.

Using the example, if the processed search query is

“Chevrolet Camaro introduced”,

in a first search most likely to return useful results if any results are returned at all, the initial search string becomes:

“‘Chevrolet Camaro introduced’”

(note quotation marks).

In a second search somewhat less likely to return useful results (but likely to return at least some significant results), the initial search string may become:

“Chevrolet AND Camaro AND introduced”.

In a third search far less likely to return useful results (but most likely to return many results), the initial search string may become:

“Chevrolet OR Camaro OR introduced”.

Referring to FIGS. 11 and 14, in step 192, via loop 194, the search string is then transferred to all search engines in a predetermined search engine array 121 and the various search results therefrom retrieved. Preferably, array 121 will have multiple search engines 26 specified, but at least one search engine 26 must be specified. Examples of suitable search engines would include “www.google.com”, “www.yahoo.com” and “www.altavista.com”. Meta-search engines may also be specified in array 121. Examples of suitable meta-search engines would include “www.dogpile.com” and “www.momma.com”. In the illustrated embodiment, the search string is transferred to the search engines 26 sequentially, i.e. essentially in series one after the other.

In step 196, a first search engine specified in array 121, say engine 26a, is accessed, the search string is inputted thereto and the search results returned. Search engine 26a generates a search report comprising a preliminary set of potentially relevant search results, each result with a link to an underlying document. For example, referring to FIG. 6, search engine 26a searches the Internet 4i and generates search results relating to the documents 28a-1 to 28a-m that it identifies as potentially relevant. Typically, the search results are returned in a search report in the form of a hypertext mark-up language (“html”) document comprising one or more pages.

In a next step 198, links from the returned search report are extracted and placed into links array 132. The number of links extracted may be limited in any suitable manner by any pre-determined rule(s) (for example, by a maximum number of search report pages, by a maximum number of links, by a maximum amount of time to complete a search).

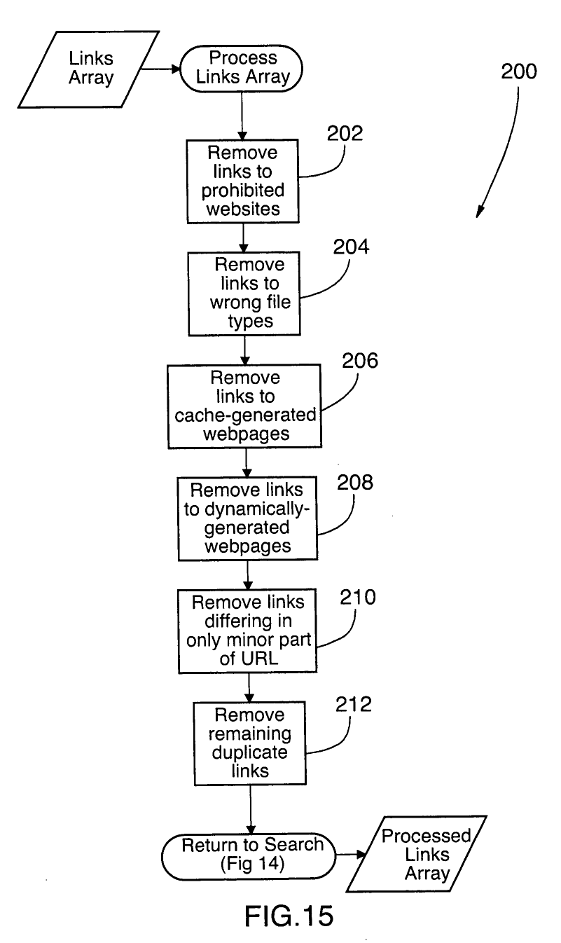

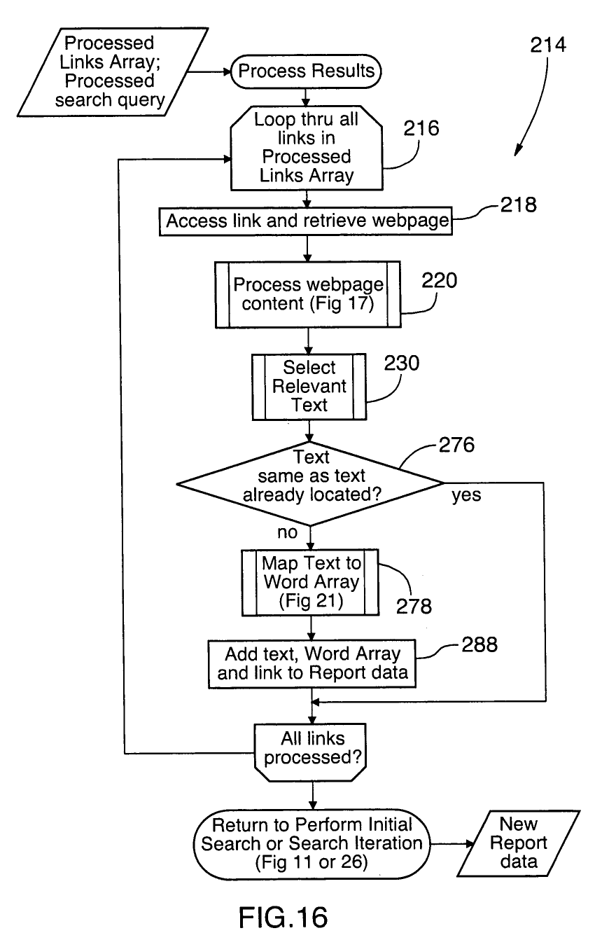

In a next step 200, the set of extracted links from the search report, namely links array 132, may be processed. For example, as shown in FIG. 15, in step 202, links to prohibited websites may be eliminated. In step 204, links to certain file types may be eliminated (for example, for software not capable of processing audio or video files, links to files of such type may be eliminated). In steps 206 and 208, links to cache-generated and dynamically-generated web pages may be eliminated. In step 210, links differing only in a minor part of its URL as compared to a previous link in links array 132 may be eliminated. In step 212, duplicate links may be eliminated.

The set of links in an array 132 may be processed in batch according to step 200 as described above. Alternatively, each link may be immediately processed as in step 200 as it is extracted from the search report before being added to array 132.

Referring back to FIG. 14, when all links from the search report from the first search engine 26a have been processed in accordance with the above, then the search string is passed through the next search engine, if any, in the search engine array 121. Links from the search reports generated by the additional search engines, e.g. 26b and 26c, are added to links array 132 as previously processed to that point. The process is repeated until the search string has been passed through all search engines 26 in search engine array 121.

Referring to FIG. 11, after the last search report has been returned and links therefrom processed and added to links array 132 as described above, further processing of the search results, namely as represented by the final content of the processed links array 132, takes place in step 214.

Referring to FIG. 16, in step 214, via loop 216, each link in final processed links array 132 is automatically and sequentially followed to the underlying document (i.e. webpage) which is then processed to select and extract potentially relevant portions of the searchable text thereof. More specifically, in step 218, a first link in links array 132 is followed and the first underlying webpage is returned.

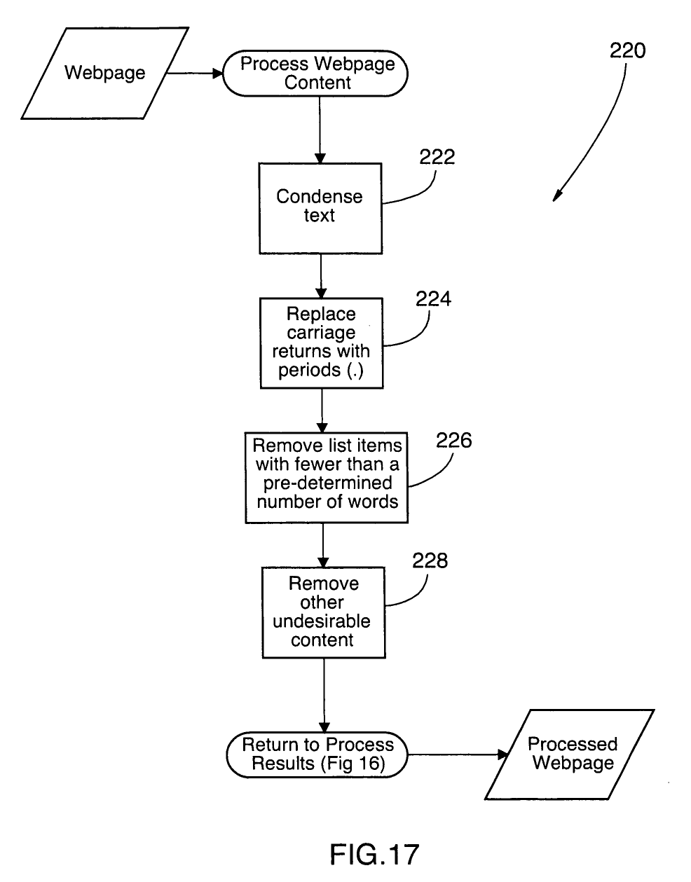

For ease of subsequent processing, in an optional preliminary webpage processing step 220, the content of the first underlying webpage may be processed, for example as shown in FIG. 17, to condense the text thereof (step 222) by removing blank lines, carriage returns and the like, to replace carriage returns with periods (step 224), to remove list items with fewer than a predetermined number of words (step 226), and/or to remove any or all other content that may be considered undesirable (step 228) such as:
1. material outside the BODY tag;
2. non-standard or other HTML tags;
3. comments;
4. java script;
5. iframes;
6. text styles and formatting;
7. HREF tags;
8. table cells;
9. layers; and/or,
10. extra title tags.

Referring back to FIG. 16, as a next step 230, the searchable text of the underlying webpage is searched to locate the terms in the processed search query and select at least one portion of such searchable text for possible inclusion in a report to the user. The text in the vicinity of the final search query terms is processed to select structure which satisfies certain pre-determined characteristics. In the embodiment described, the pre-determined characteristics are rules to determine the presence of sentence-based text in the vicinity of the final search query terms. It is believed that the presence of such sentence-based text will be indicative of natural language which will be more likely to provide useful information in response to the search query. It is also believed that, conversely, text which is not sentence-based (e.g. single words, short phrases, meta-tags) are more likely to be indicative of the application of various SEO techniques (e.g. words used merely to attract a user to a website or to encourage a conventional search engine to give higher ranking to the website in a search report) and thus less likely to be relevant to a user searching for useful information on a particular topic.

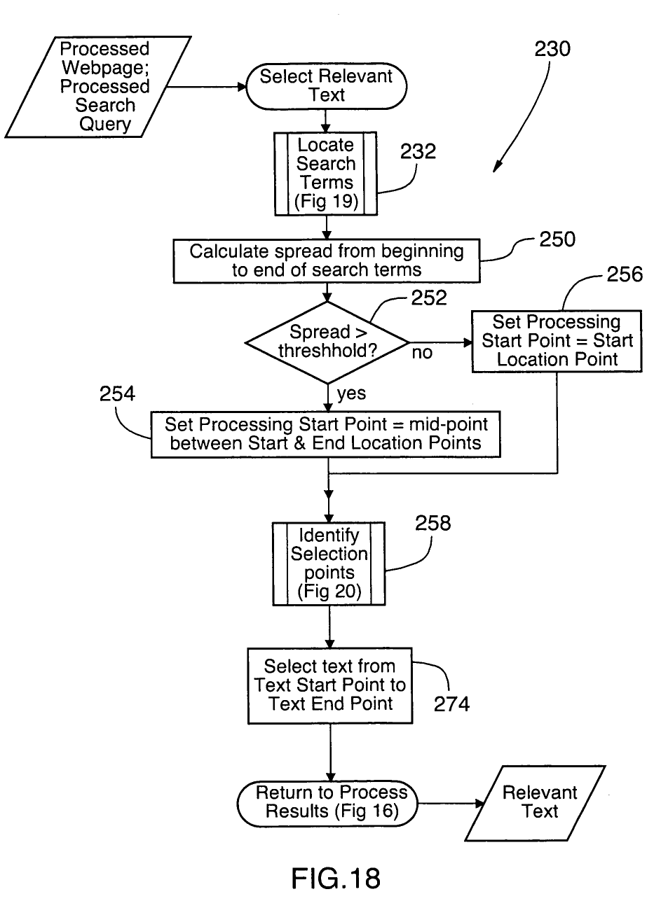

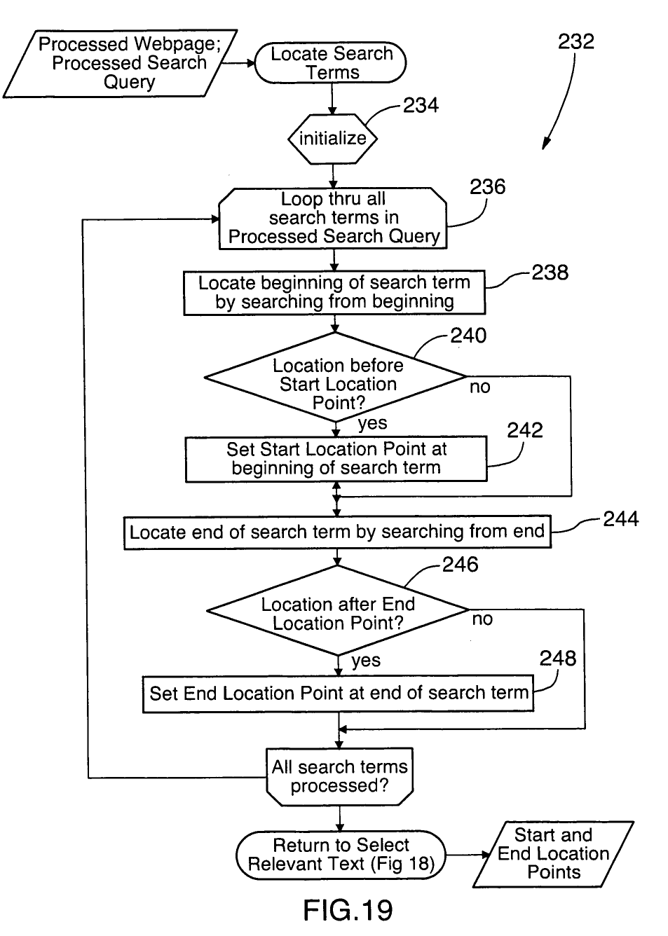

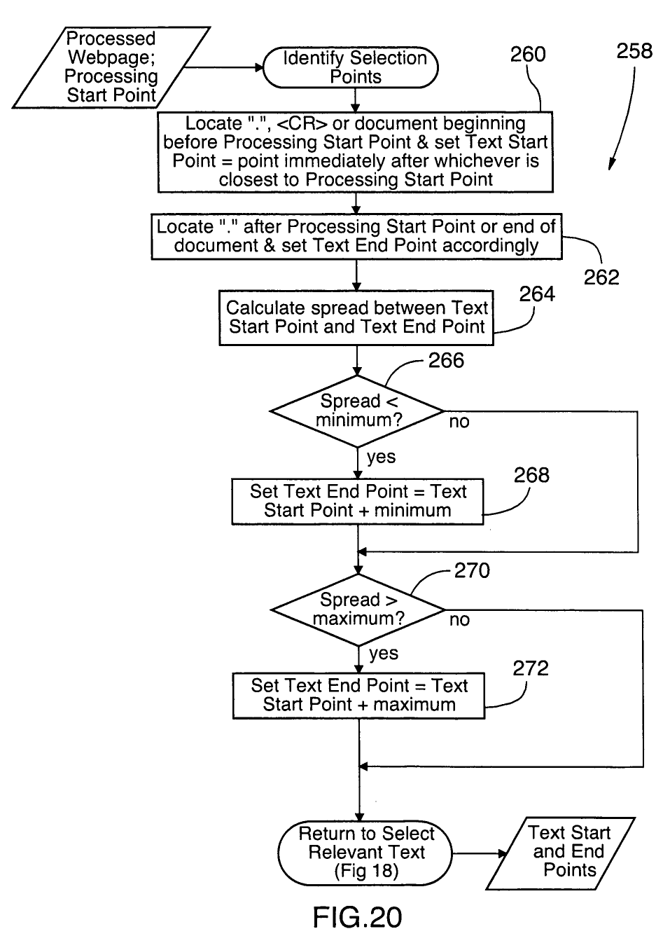

In step 230, the text surrounding the located search terms is searched for and automatically selected according to pre-determined criteria. For example, as shown in FIGS. 18 and 19, it is believed that the following specific but exemplary criteria will provide a useful amount of context to the search results:
1. in step 232, after an initialization step 234, each search term in the processed search query is searched for in the text in a loop 236;
2. in step 238, the first appearance of a search term in a webpage is located by searching the webpage from the beginning. The beginning of the search term becomes the start location point;
3. in test 240, if said start location point is before the start location point derived for an earlier search term, in step 242, said start location point becomes the new start location point;
4. in step 244, the webpage is similarly checked for a second appearance of the search term (or the end of the first appearance of the search term) by searching the webpage from the end. The end of the search term becomes the end location point;
5. in test 246, if said end location point is after the end location point derived for an earlier search term, in step 248, said end location point becomes the new end location point;
6. all search terms are looped through in loop 236, until the earliest start and the latest end points are identified;
7. referring to FIG. 18, in step 250, the spread (that is, the difference in position or the number of text characters) between the earliest start and the latest end points is calculated;
8. in test 252, if the spread exceeds a pre-determined threshold number of characters (e.g. 550 characters is believed to return useful results), processing for text selection will start at a point in the text mid-way between the earliest start and the latest end points. A processing start point is determined accordingly in step 254;
9. if the spread does not exceed the pre-determined threshold in test 252, processing for text selection will start at the earliest start point. A processing start point is determined accordingly in step 256;
10. referring to FIG. 20, from the processing start point, actual text is selected in step 258, according to the following criteria:
   i. in step 260, the beginning of the sentence in which the processing start point is located is identified by identification of the end of the preceding sentence or paragraph. This is achieved by identification of the preceding “period” (i.e. a “.” marking the end of the preceding sentence) or of a preceding carriage return (i.e. a <CR> marking the end of the preceding paragraph) or of the beginning of the document, whichever is closest to the processing starting point. The text selection will start with the character next immediately following such identification (“Text Starting Point”).
   ii. in step 262, text selection will continue from the Text Starting Point until at least the end of the sentence in which the Text Selection Starting Point or the end of the document is located. This is achieved by identification of the first “period” following the Text Selection Starting Point, which “period” will become the preliminary end point for the text selection (“Text End Point”).
   iii. in step 264, the spread between the Text Starting Point and the Text End Point is calculated;
   iv. if the spread is small (i.e. the natural language sentence is short, namely the number of characters is small), the text selection end point may be moved to include more text. More specifically, in test 266, the spread is compared to a predetermined minimum number of characters. If the spread is less than the minimum, the Text End Point will be moved to the Text Start Point plus the minimum. In this manner, a reasonable amount of text will be included in the text selection. A predetermined minimum number of characters equal to 550 is believed to return good results;
   v. if the spread is large (i.e. the sentence is unusually long, namely the number of characters is large), the text selection end point may be moved to the point where the text selection will end at the maximum number of characters. More specifically, in test 270, the spread is compared to a predetermined maximum number of characters. If the spread is greater than the maximum, the Text End Point will be moved to the Text Start Point plus the maximum. In such cases, although the text selection may not include an entire sentence, it should nevertheless contain a significant amount of information. A predetermined maximum number of characters equal to 1,100 is believed to return reasonable results;
11. referring to FIG. 18, in step 274, the text from the Text Start Point to the Text End Point is selected for inclusion as a possible text extract in a possible report to the user, along with the link leading to the particular webpage and any other relevant information for webpage, such as appropriate identification information (e.g. webpage title, date of creation or last modification of the webpage).

Other sentence-based rules may also be preferred according to a user's preferences. For example, the predetermined criteria may adjusted to extend text selection to include additional adjacent sentences either before and/or after the basic text selection according to the above.

It will be appreciated that, for any particular webpage, it is possible there may be more than one portion of the text, possibly widely separated, which would include the search terms. However, in the preferred embodiment of the invention, this possibility would not be pertinent, as only one text extract, selected according to the parameters described above, would be identified for possible inclusion in the search report. Given that processing start point could be in-between the portions of the text containing the search terms, it is possible that the selected text will not include any search term. Nevetheless, it is believed that even in such a case the text selected will be of potential relevance to the user. In other embodiments of the invention, more than one or all portions of the text containing the search terms in the underlying webpage could be identified for possible inclusion in a search report.

Referring again to FIG. 16, a text extract identified for possible inclusion in a search report may be compared in a test 276 to any previous text extracts identified for possible inclusion in a search report. If a proposed text extract is determined to be a duplicate of an already proposed text extract (e.g. perhaps from different websites), it may be eliminated from inclusion in a search report.

In an optional but preferred step 278, the words of the text extract are processed and any words in such extract which are unique as compared to the words of other text extracts to be included in a report are mapped to a word array to be associated with such text extract. The details and purpose are described below in further detail.

Notwithstanding the anticipated return of an initial search report to the user in accordance with the methods described herein, it can be expected that the user may nevertheless wish to try to refine the search. To assist in such refinement process, it is contemplated that a user may find it useful to identify certain text extract entries in a search report as being “relevant”/“not relevant” or “of interest”/“not of interest” or that he or she would like results “more like this”/“less like that”. The word arrays associated with the text extracts will be used herein to assist in such a search refinement process, in a manner to be described below.

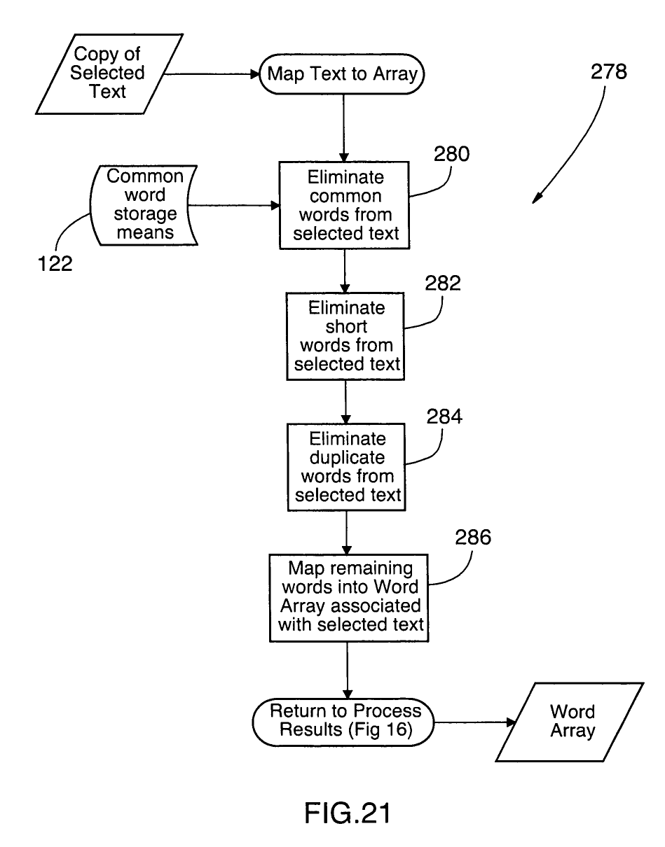

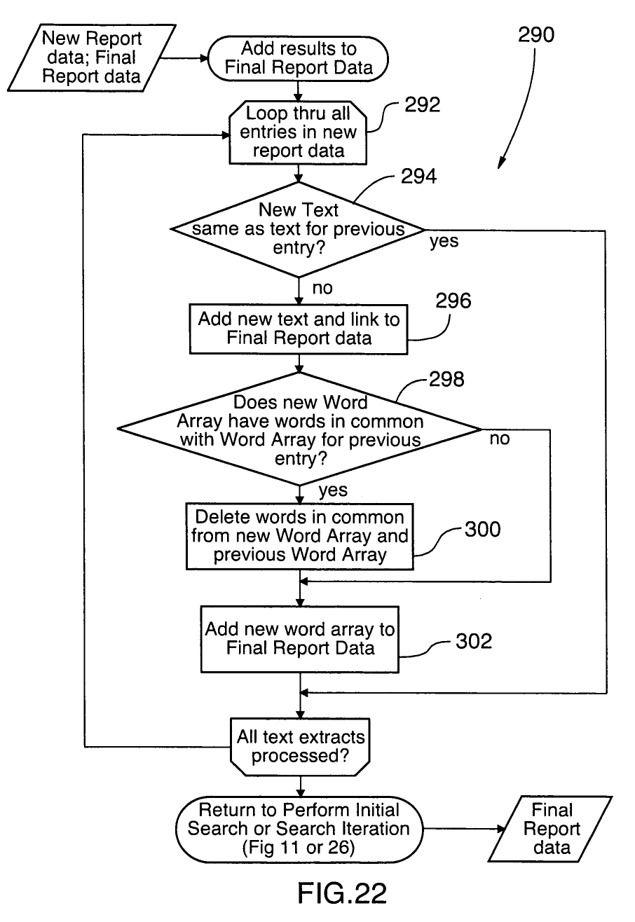

Referring to FIG. 21, a text selection or extract is processed in the following manner. On the theory that common words will not assist in search refinement, in an initial processing step 280, all common words stored in common word means 122 are eliminated from the text extract. On the theory that other short words will not assist in search refinement, in a next step 282, all short words (e.g. 3 letters or less) are eliminated from the text extract. In a next step 284, any duplicate words may be eliminated. Finally, in step 286, the remaining words in the processed text extract are mapped into a word array.

By way of example, if the text extract reads:
Chevrolet Camaro Chevrolet Camaro Manufacturer Class Platform Related. The Chevrolet Camaro is a popular pony car made in North American by the Chevrolet Motor Division of General Motors. It was introduced on 29 Sep. 1966 Ä the start of the 1967 model year Ä as a competitor of the Ford Mustang. The car shared the platform and major components with the Pontiac Firebird, also introduced in 1967. Four distinct generations of the car were produced before production ended in 2002. A new Camaro is expected to roll off assembly lines in 2009.

The word array associated therewith, after elimination of the various types of words noted above, may be rendered as shown in Table 1.

TABLE 1
First Array

| Chevrolet | Camaro | Manufacturer | Class | Platform | Related |
|---|---|---|---|---|---|
| popular | pony | made | North | American | Motor |
| Division | General | Motors | introduced | 29 | September |
| 1966 | start | 1967 | model | year | competitor |
| Ford | Mustang | shared | major | components | |
| Pontiac | Firebird | also | introduced | 1967 | Four |
| distinct | generations | produced | before | production | ended |
| 2002 | expected | roll | assembly | lines | 2009 |

Referring again to FIG. 16, in step 288, any text extract not eliminated by test 276 is, together with its associated link and word array from step 278, added to the new data to be included in a report to the user. The process is repeated for each link in the processed links array 132.

Referring now to FIG. 11, in step 290, such new data is collated with data already accumulating for inclusion in a report to the user. Because loop 174 can be expected to deliver different results for different iterations of the searches therein, the data from a later iteration, i.e. the new data, must be merged with the data from an earlier iteration.

Referring to FIG. 22, in loop 292, all new report data are compared with existing report data and additions and modifications as specified are made to the data to result in a set of final report data. More specifically, a new text extract being considered for possible inclusion in the final report data may be compared in a test 294 to any previous text extracts already identified for inclusion in the final report data. If the new text extract is determined to be a duplicate of an already proposed text extract (e.g. perhaps from different websites), it and any associated data may be eliminated from inclusion in the final report data. If the new text extract is not a duplicate of a previous entry, in step 296, the new text extract and its associated link will be added to the final report data. Any associated word array will, however, be subject to further processing. In particular, in test 298, the contents of the new word array will be compared with those of the word arrays associated with all other entries already included in the final report data. In step 300, if the new word array has a word in common with a previous word array, the word is deleted from both word arrays. In particular, the word array associated with a previous text entry is modified to delete the word in common. The word is also deleted from the new word array and, in step 302, the modified new word array is added to the final report data in association with the new text extract and associated link.

By way of example, consider a further example of text relating to the “Chevrolet Camaro” in which the associated word array is:

TABLE 2
Second Array

| | | | | | |
|---|---|---|---|---|---|
| August | 29 | 2002 | bright | Chevrolet | Camaro |
| rolled | down | assembly | line | General | Motors |
| Therese | plant | outside | Montreal | Quebec | ending |
| 35 | years | automobile | history | GM | handed |
| pony | market | archrival | Ford | Mustang | Since |
| time | only | almost | spit | grave | GM's |
| F-bodies | displayed | concept | version | next | matter |
| months | later | Firebird | introduced | September | 1966 |
| developed | cult | following | | | |

In step 298, it would be determined that the Second Array (Table 2) contains words in common with the First Array (Table 1). In step 300, the words in common are deleted from both arrays. The modified arrays would appear as:

TABLE 3
First Array (Modified)

| Manufacturer | Class | Platform | Related | popular | made |
|---|---|---|---|---|---|
| North | American | Motor | Division | | start |
| 1967 | model | year | competitor | shared | major |
| components | Pontiac | also | 1967 | Four | distinct |
| generations | produced | before | production | ended | expected |
| roll | lines | 2009 | | | |

and

TABLE 4
Second Array (Modified).

| | | | | | |
|---|---|---|---|---|---|
| August | bright | rolled | down | line | Therese |
| plant | outside | Montreal | Quebec | ending | 35 |
| years | automobile | history | GM | handed | market |
| archrival | Since | time | only | almost | spit |
| grave | GM's | F-bodies | displayed | concept | version |
| next | matter | months | later | developed | cult |
| following | | | | | |

After similar processing to compare all arrays for all text entries with each other, the above arrays may, for example, be modified to the following:

TABLE 5
First Array (As Finally Modified)

| | |
|---|---|
| generations | 2009 |

TABLE 6
Second Array (As Finally Modified)

| | |
|---|---|
| Montreal | cult |

Thus, after such processing, the text extract for each entry of the search report has associated with it an array of any text unique (in the context of such search report) to that entry. The existence of all such arrays may be hidden to the user, i.e. not included in any search report actually presented to the user, and may simply be retained and used internally by search engine 104 in the event that the user wishes to refine the search based on the method hereinafter described.

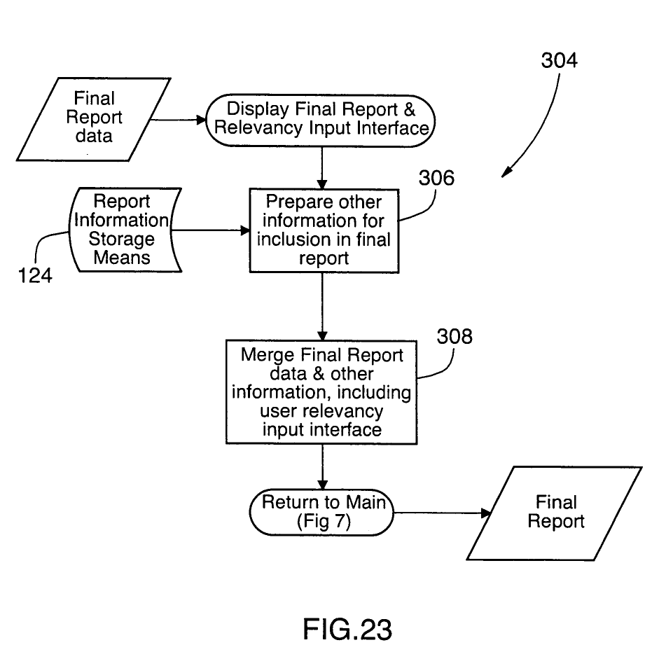

Referring to FIG. 7, after the initial search is completed, in step 304, the final report data is processed for final display. More specifically, referring to FIG. 23, in a step 306, other information as stored in (or generated from information stored in) report template storage means 124 is prepared for inclusion in a final report. This information may include data fields to provide an opportunity for a user to provide relevancy feedback to search engine 104. In step 308, the final report data is merged with such other information in a final report. As shown in FIG. 7, the final report is displayed to the user at computer 2.

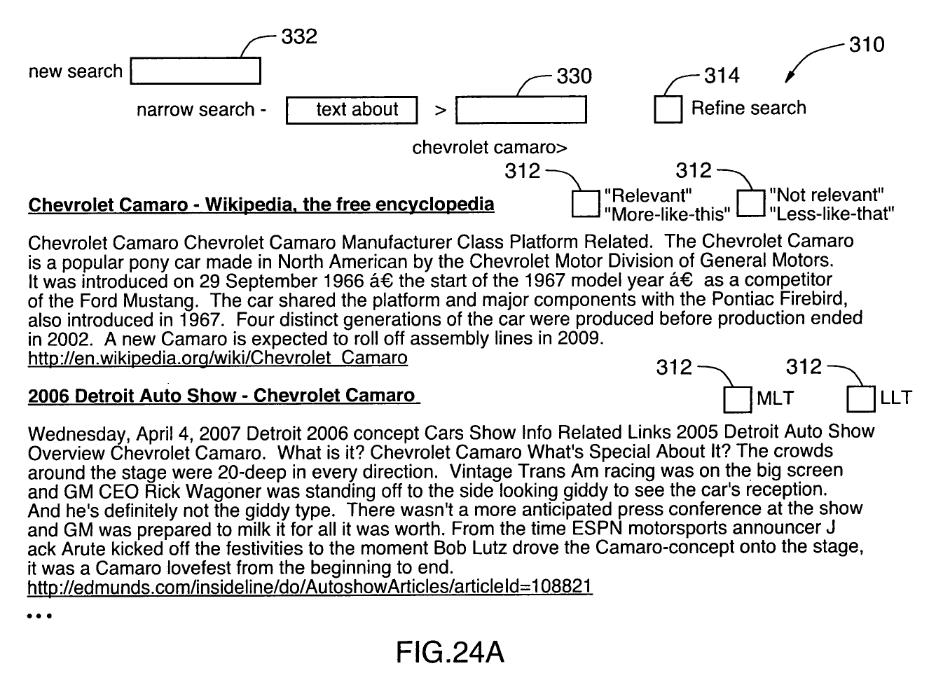

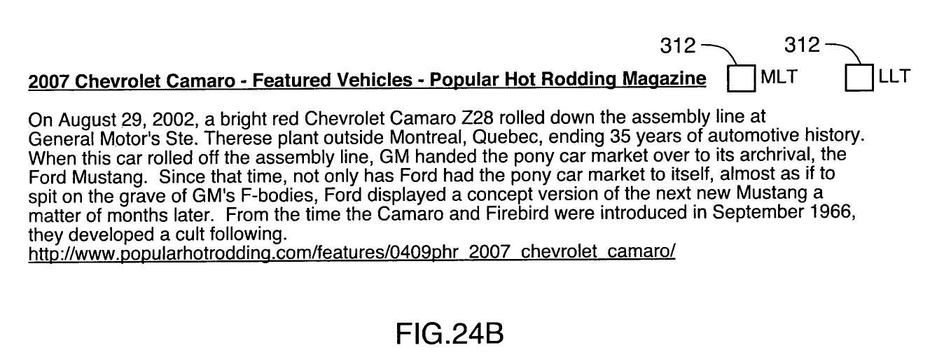

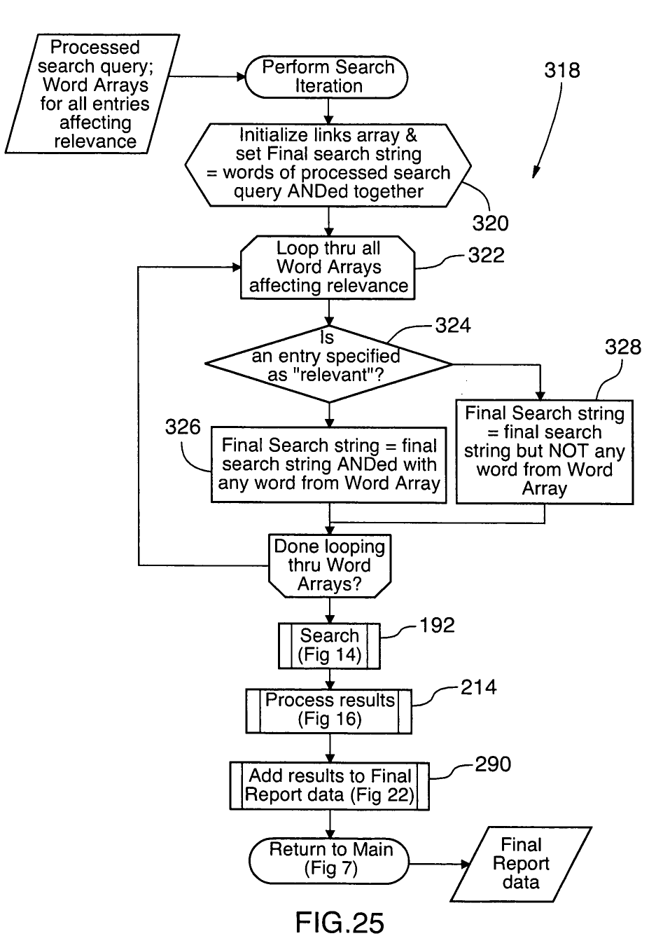

A sample print-out of a search report generated according to the above-described process, and which includes an interface, generally indicated as 310, for the input of relevancy data relating to the returned results, is included as FIG. 24.

The report of FIG. 24 provides a useful quantity of information to the user, in a manner efficient to the user in that he/she is not required to review the underlying document to ascertain its relevance (thus automatically avoiding the need to review a possible large quantity of potentially irrelevant information in the underlying document) or to assess clearly irrelevant (i.e. non-sentence-based text) or duplicate or similar entries that may have been included in a conventional search engine search report for example as a result of various SEO techniques.

It will be appreciated that, as described above, generation of a final search report returned to the user in step 304 can wait until the processing of all links in links array 132 has been completed. However, some users may prefer that the search report be generated dynamically by being built up and displayed to the user as the links are processed and as the entries to the results list accumulate.

Referring to FIGS. 7 and 24, search refinement may be achieved in the following manner. Search method 150 is capable of inviting and receiving input from a user, via interface 310, in response to a first report returned to the user. In particular, the search report returned to the user presents an interface 310 allowing the user to provide feedback to the search engine 104 as to whether, in a further iteration of the search, further results should be similar to, or dissimilar to, one or more entries in the initial search report. More specifically, data fields 312 are associated with each entry in the search report to allow a user to provide feedback to the search engine 104 as to whether entries selected by the user should be treated as “relevant” or “not relevant” [or “of interest”/“not of interest” or “more like this”/“less like that”] in a subsequent iteration of the search. In short, the user is provided with a mechanism to provide feedback as to whether subsequent search results should include entries which are “like this” (i.e. the user wants results which are “more like this”) or exclude items which are “like that” (i.e. the user wants results which are “less like that”).

When the user has selected at least one entry in the search results, for example by clicking on appropriate check boxes 312, the user forwards his or her selections to search engine 104 by pressing a “refine search” button 314.

Referring to FIG. 7, at step 304, relevance data input via interface 310 is received. Test 316 monitors for the presence of relevance data. If no relevance data is received, further processing comes to an end. If relevance data is received, the search is iterated in step 318.

Referring to FIG. 26, in an initializing step 320, links array 132 is initialized and the final search string is set equal to the words of the processed search query from step 162 joined by logical ANDs. In loop 322, the word arrays associated with search result entries noted by the user as being “relevant” or “not relevant” [or “of interest”/“not of interest” or “more like this”/“less like that”] are examined sequentially. Test 324 determines whether a user has identified an entry as “relevant” or “not relevant”. If the entry has been marked as “relevant”, in step 326, the search string will be modified to add any word of the word array by means of logical ANDs and ORs. On the other hand, if the entry has been marked as “not relevant”, in step 328, all words in the word array associated with the entry will be subtracted from the search string by means of logical NOTs. When loop 322 is done, a new search string will be complete and ready to be used to perform new searches.

For example, assume that the user's initial search query was

“When was the *# Chevrolet Camaro introduced?”

and that the user identified only the fourth entry in FIG. 24 as relevant (the word array for which is depicted in Table 6). As described above, the processed search query became

“Chevrolet Camaro introduced”.

The word array of Table 6 identified the words “Montreal” and “cult” as the only unique words in that entry, as compared to the other entries in the search report. The method of step 318 will now include such unique words in a modified search query by adding them to the final search query, in the following manner:

“Chevrolet AND Camaro AND introduced AND (Montreal OR cult)”.

In a case where the user indicated that an entry was not relevant or that further results should be “less like that”, then the search query would be modified to exclude the associated unique words from a modified search query by excluding them from the final search query, for example as in

“Chevrolet AND Camaro AND introduced BUT NOT (Montreal OR cult)”.

If a user-selected entry in fact had no unique text as compared to other entries (i.e. there were no entries in its associated word array), such selected entry could not be used to refine the search results. A suitable message to such effect may be displayed to the user and/or the feedback fields 312 de-activated or not displayed.

If a user-selected entry in fact has a large amount of unique text, as compared to other entries, it may be necessary from a practical perspective to limit the quantity of potential unique terms which may be used in subsequent searching. Such limitation may have to be somewhat arbitrary (e.g. by mere truncation of the available list of unique words to a maximum number, such as 100). If useful search results are not obtained, it may be necessary to rely on use of other entries in the search results to achieve better results in a subsequent search iteration.

Referring again to FIG. 26, the final search string is passed to search step 192, the process results step 214 and the add-results-to-final-report-data step 290.

Search iterations may be performed one at a time based on selection of search result entries one at a time as being relevant/not-relevant, whereby the search query is modified essentially on an entry-by-entry basis. Alternatively, the procedure may be implemented to allow the user to identify multiple entries as being relevant/not-relevant, in which case the search query may be modified in complex manner to accommodate the user's various inputs.

In a case where a search report is generated dynamically by being built up and displayed to the user as the entries to the results list accumulate, the feedback mechanism described above may be enabled as soon as there are at least two entries in the results list.

It is important to appreciate that the strategy for refinement of a search is focused not on the entirety of the full text of an underlying document but instead only on a subset thereof, namely on the unique words in the word array which is derived from the text extract in the vicinity of the search terms. If the entirety of the full text of the underlying documents were assessed for additional possible search terms, a large number of potentially irrelevant documents could subsequently be located.

The embodiment of the inventive search method described above is of the “opaque” relevance feedback type. In another embodiment, as a “transparent” relevance feedback model, an automatically generated modified search query may be displayed to the user after execution of the refined search. In yet another embodiment, as a “penetrable” relevance feedback model, an automatically generated modified search query may be presented back to the user, for acceptance or possible user editing, before execution of the refined search.

As an alternative or additional approach to search refinement, search engine 104 may allow the user to directly input additional terms into a search query, in essence as a sub-search. For example, interface 310 may provide a field 330 for the user to input additional search terms. By way of example, if the initial search query was:

“Chevrolet and Camaro”

the user may quickly find that there are too many results to answer his real question about when the vehicle was introduced. Accordingly, the user may wish to manually add in the additional search term

“Introduced”

Accordingly, a second iteration of the search may comprise the search query: “Chevrolet and Camaro and Introduced”.

In addition to the above, search engine 104 may also allow the user to start a new search by inputting new search terms. For example, interface 310 may provide a field 332 for the user to input new search terms and thus start the search process over again.

Search engine 104 preferably maintains an array of previous search queries generated in a particular search session. For reasons of practicality, the number of search queries retained may have to be limited. In practice, an array capable of retaining 10 search queries, each with up to 10 search keywords has been found to be useful. The array may be used as a history of the searching done in respect of the particular topic, so that for example if the user did not like the results obtained in a later search iteration, he or she could easily revert to an earlier preferred search iteration. If individual search results are stored even temporarily, the array could be linked, if desired, to the specific results for each search query, for quick access thereto. If search results are not stored and/or linked to the search array, then reverting to an older search query may simply result in a re-running of the older search.

A search may be refined and iterated in accordance with the above processes as many times as the user finds useful.

It will be appreciated that a certain amount of time and computing power is required to follow all the links in links array 132 to the underlying documents and to process them to select and extract potentially relevant portions of the searchable text thereof, all as described above. In a further embodiment of the invention, referring to FIGS. 5 and 6, a storage device 126 may be provided to receive and store a report database of previous search reports generated by search engine 104 in response to searches previously conducted by any users. Search reports may be stored and indexed to the final search query which generated them. Accordingly, after the user's search query has been processed in step 158 (see FIG. 7), a database search step may be introduced whereby the processed search query is compared to the search queries for the search reports previously stored in report database. If a match is located, the previous search report associated therewith and stored in the report database may be quickly displayed to the user providing a very quick response to the user's initial search query. In some cases, such a report may be completely adequate for a user's purposes or it may at least serve as a good basis for starting new iterations of the search. If there are multiple search reports in the report database relating to the final search query, a list thereof may be returned to the user for quick selection. It may also be desirable to maintain a count, associated with each report in the report database, as to the number of times each report is accessed by users. Such a count may serve as a measure of a particular search report's popularity or usefulness to users. Accordingly, if the report database contains multiple search reports relating to a particular query, the highest count, or ‘most popular’, report may be the one returned to the user.

The invention has been described in relation primarily to its application to a document store which is the Internet 4i. However, as generally shown in FIG. 5, it will be appreciated that the method of the invention is equally applicable to other types of document stores 4 of documents containing searchable text such as intranet systems or dedicated or specialized databases. In a case where search software 14 is specialized search software, search engine 104 will incorporate a suitable interface to allow appropriate communication therebetween.

The method of the present invention can be executed on conventional computer hardware using conventional operating systems by means of software running on suitable processors or by any suitable combination of hardware and software. The software can be accessed by a processor using any suitable reader device which can read the medium on which the software is stored.

One of ordinary skill in the art, having studied the specification herein including drawings, will be able to write software code using conventional programming languages to carry out the steps of the method of the invention set forth herein.

The software may be stored on any suitable computer-readable storage medium including for example: compact discs such as CD-ROMs, DVDs; magnetic storage media such as magnetic disc (such as a floppy disc) or magnetic tape; optical storage media such as optical disc, optical tape, or machine-readable bar code; solid state electronic storage devices such as random access memory (RAM) or read only memory (ROM); or any other physical device or medium employed to store a computer program. The software carries program code which, when read by the computer, causes the computer to execute any or all of the steps of the methods disclosed in this application.

Although various preferred embodiments of the present invention have been described herein in detail, it will be appreciated by those skilled in the art, that variations and modifications may be made thereto without departing from the scope of the appended claims.

1. A method of searching an information store, in which documents containing searchable text are stored, for specific information comprising:
a. inputting a search query into a search interface;
b. processing the search query to generate a search string incorporating search terms relating to the search query;
c. transferring the search string to at least one search engine to generate a preliminary set of potentially relevant results, each result with a link to an underlying document in the information store;
d. automatically following the links to the underlying documents and locating the search terms therein;
e. automatically selecting a text extract from the full searchable text of each underlying document based on the location of the search terms therein and pre-determined criteria applied thereto;
f. generating a results list by adding the text extract and other information relating to the underlying document as an entry in the results list;
g. identifying, for each text extract, any words therein which are unique as compared to the text extracts for all other entries in the results list;
h. selecting from the results list at least one entry with one or more unique words associated therewith;
i. automatically generating a modified search string based on said one or more unique words; and,
j. repeating steps (c) to (f) by transferring the modified search string to said at least one search engine to generate a modified results list.

2. The method of claim 1 wherein said information store is the Internet.

3. The method of claim 2 wherein said documents comprise web content in the form of one or more webpages and searchable documents posted to the Internet.

4. The method of claim 1 wherein said information store is a database.

5. The method of claim 1 wherein the step of generating a modified search string comprises adding said one or more unique words to the search string.

6. The method of claim 1 wherein the step of generating a modified search string comprises excluding said one or more unique words from the scope of the search string.

7. The method of claim 1 wherein the step of selecting at least one entry in the list of results comprises selecting said at least one entry for inclusion or exclusion from a refined search and wherein the step of generating a modified search string comprises:
a. if said at least one entry was selected for inclusion, adding the one or more unique words to the search string; and,
b. if said at least one entry was selected for exclusion, excluding the one or more unique text from the scope of the search string.

8. The method of claim 7 wherein said pre-determined criteria comprise identifying a processing start point based on the locations of the search terms in the text and sentence-based rules for determining a text selection starting point before the processing start point and a text selection ending point after the text selection starting point.

9. The method of claim 8 wherein said sentence-based rules comprise rules that a text selection shall exceed a minimum size and that text selection shall include only full sentences.

10. The method of claim 9 further comprising a step of processing the links associated with the preliminary list of results to eliminate certain links according to pre-determined elimination rules and wherein the step of automatically following links applies only to links not eliminated.

11. The method of claim 10 further wherein the elimination rules comprise one or more of the following: elimination of duplicate links, elimination of links different only in a minor part of a URL or other address, elimination of pre-determined prohibited websites or documents, elimination of links to prohibited file types, elimination of dynamically-generated webpages and elimination of cache-generated webpages.

12. The method of claim 11 further comprising limiting the number of links to be followed according to a pre-determined rule.

13. The method of claim 12 wherein the pre-determined rule is based on a maximum number of links.

14. The method of claim 12 wherein the pre-determined rule is based on a maximum search time.

15. The method of claim 12 wherein the pre-determined rule is based on a maximum number of results to be included in the refined list of results.

16. The method of claim 12 wherein the step of transferring the search string to at least one search engine comprises transferring the search string to two or more search engines and generating a preliminary set of potentially relevant results by combining results generated by each said search engine in response to the search string, each result having a link to an underlying document in the information store.

17. The method of claim 16 wherein the search string is transferred to said two or more search engines sequentially.

18. The method of claim 16 or 17 wherein the list of results is returned as it is being built up.

19. The method of claim 18 wherein steps (h) to (j) may be executed as soon as there are at least two entries in the list of results.

20. The method of claim 12 wherein the at least one search engine is a meta-search engine.

21. A computer data processing system for searching an information store, in which documents containing searchable text are stored, for specific information in response to a user search query, the system comprising:
a. a first user interface for entering a search query;
b. a display device for displaying reports;
c. a second user interface for inputting data in response to a displayed report;
d. at least one search computer processing means connected to the information store for searching the information store in response to a search string inputted thereto;
e. a central computer connected to the at least one search computer processing means, the first and second user interfaces and the display device for:
i. receiving and processing the search query to generate a search string incorporating search terms relating to the search query;
ii. transferring the search string to the at least one search computer processing means;
iii. receiving from the at least one search computer processing means a preliminary set of potentially relevant results, each result with a link to an underlying document in the information store;
iv. automatically following the links to the underlying documents and locating the search terms therein;
v. automatically selecting a text extract from the full searchable text of each underlying document based on the location of the search terms therein and pre-determined criteria applied thereto;
vi. generating a results list by adding the text extract and other information relating to the underlying document as an entry in the results list and displaying a report based thereon on the display device;
vii. identifying, for each text extract, any words therein which are unique as compared to the text extracts for all other entries in the results list;
viii. receiving from the second user interface data relating to at least one entry in the results list with one or more unique words associated therewith;
ix. automatically generating a modified search string based on said one or more unique words; and,
x. iterating a search by transferring the modified search string to said at least one search computer processing means to generate a modified results list.

22. Computer software for searching an information store, in which documents containing searchable text are stored, for specific information in response to a user search query, comprising a computer usable medium having computer-readable program code embodied therein, said computer-readable program code comprising:
i. a first program code for receiving and processing the search query to generate a search string incorporating search terms relating to the search query;
ii. a second program code for transferring the search string to at least one search computer processing means connected to the information store for searching the information store in response to the search string;
iii. a third program code for receiving from the at least one search computer processing means a preliminary set of potentially relevant results, each result with a link to an underlying document in the information store;
iv. a fourth program code for automatically following the links to the underlying documents and locating the search terms therein and for automatically selecting a text extract from the full searchable text of each underlying document based on the location of the search terms therein and pre-determined criteria applied thereto;
v. a fifth program code for generating a results list by adding the text extract and other information relating to the underlying document as an entry in the results list and for outputting a report based thereon for display on a display device;
vi. a sixth program code for identifying, for each text extract, any words therein which are unique as compared to the text extracts for all other entries in the results list;
vii. a seventh program code for receiving user relevance data relating to at least one entry in the results list with one or more unique words associated therewith and for automatically generating a modified search string based on said one or more unique words and for transferring the modified search string to said at least one search computer processing means to generate a modified results list.

23. A computer processor for searching an information store, in which documents containing searchable text are stored, for specific information in response to a user search query, the processor adaptable to be connected to the information store and to at least one search computer processing means connected to the information store for searching the information store in response to a search string inputted thereto, a first user interface for entering a search query, a display device for displaying reports, and a second user interface for inputting data in response to a displayed report, the processor comprising
i. means for receiving from the first user interface and processing the search query to generate a search string incorporating search terms relating to the search query;
ii. means for transferring the search string to the at least one search computer processing means;
iii. means for receiving from the at least one search computer processing means a preliminary set of potentially relevant results, each result with a link to an underlying document in the information store;
iv. means for automatically following the links to the underlying documents and locating the search terms therein;
v. means for automatically selecting a text extract from the full searchable text of each underlying document based on the location of the search terms therein and pre-determined criteria applied thereto;
vi. means for generating a results list by adding the text extract and other information relating to the underlying document as an entry in the results list and outputting a report based thereon for display on the display device;
vii. means for identifying, for each text extract, any words therein which are unique as compared to the text extracts for all other entries in the results list;
viii. means for receiving from the second user interface user relevance data relating to at least one entry in the results list with one or more unique words associated therewith;
ix. means for automatically generating a modified search string based on said one or more unique words; and,
x. means for transferring the modified search string to said at least one search computer processing means to generate a modified results list.
